(19) United States
(12) Patent Application Publication
(10) Pub. No.: US 2006/0232953 A1
(43) Pub. Date: Oct. 19, 2006

(54) Illuminated document holder

(76) Inventor: Gina M. Sanders, Chicago, IL (US)

Correspondence Address: OLSON & HIERL, LTD., 20 NORTH WACKER DRIVE, 36TH FLOOR, CHICAGO, IL, 60606, US

(21) Appl. No.: 11/106,867

(22) Filed: Apr. 15, 2005

(51) Int. Cl. F21V 33/00

(52) U.S. Cl. 362/98; 362/99; 362/234

(57) ABSTRACT

A document holder suitable for illuminating a document such as a restaurant menu for reading in dim lighting conditions. The document is removably secured to the substrate of the holder. A switch controls a light source to provide illumination of the document on demand.

### TECHNICAL FIELD OF THE INVENTION

The present invention relates generally to an illuminated document holder, and more particularly, to a document holder to facilitate the reading of menus and checks in dim environments such as restaurants.

### BACKGROUND OF THE INVENTION

Restaurants, particularly fine dining establishments, often use soft, dim lighting to create a pleasurable dining experience. While dim lighting provides an appealing ambiance, a significant drawback is presented when patrons attempt to read the restaurants' menu and bill. The problem is frequently exacerbated by the use of attractive, but small type faced or stylized lettering for the menu items.

In order to read the menus in dim environments, patrons are often forced to resort to such methods as reaching for reading glasses, asking others to read the menu to them, or requesting a large print menu, if available. Such measures are inconvenient and often embarrassing for the patron. Still others resort to reading the menu near an open flame at the table, typically present in the form of a decorative candle. This creates an added danger that the patron may inadvertently knock over the candle or suffer injury from manipulating an open flame.

Another approach is for the patron to carry a small flashlight for use in reading the menu in a dark restaurant. A disadvantage of this method is that the light source has to be carried by the user, who may feel self conscious and inconvenienced at having to carry and use the flashlight. The use of flashlights may be counterproductive to the restaurant's attempts at establishing a pleasing ambiance, as the restaurant cannot control the brightness and intensity of a patron's personal source of illumination from detracting from the otherwise pleasing lighting conditions for other diners.

Yet another method is for the patron to carry a portable magnifier, preferably one which is also illuminated to simultaneously solve the problems of dim lighting and small print. Hand-held illuminating magnifiers exist which employ a light emitting diode (“LED”) in combination with a magnifying lens. Such an approach, however, suffers the same disadvantage of requiring that the patron either carry their own or request one from the wait staff, assuming the restaurant has any available.

There is thus a need for an illuminated document holder which can be provided by the restaurant so that a patron can read a menu, wine list, check, or other document without having to be embarrassed or inconvenienced. It is also desired that the document holder be aesthetically suitable for a restaurant, especially a fine restaurant.

### SUMMARY OF THE INVENTION

The present invention relates to an illuminated document holder, such as a portfolio folder, suitable for holding a document to a surface of a substrate of the folder. Illumination is provided in the preferred embodiment by at least one LED or illuminating strip electrically connected to a power supply, such as a battery embedded in the portfolio folder, and a switch. The document can be held to the substrate either through the use of an adhesive, corner clips, sleeves, or other retaining mechanisms. A multi-page menu can be used with the portfolio folder by restraining the front and back cover to the substrate. Preferably, the substrate surface is of a size that is at least as large as the document to be presented.

When the portfolio folder is opened, the switch is activated, either manually or automatically, to turn on the light source. For example, the switch can be of the pull tab variety where one end of the tab is in contact with the switch and the other end of the tab is secured to the folder across the centerline of the folder from the switch. When the folder is opened, the tab slides across an electrical contact to automatically activate the switch. Yet another approach would be to use a photosensitive sensor to automatically activate the switch. The document is thus illuminated by the light source for improved readability. When the folder is closed, the switch preferably deactivates the light source to conserve the battery. Alternatively, the switch can be manually operated and discreetly located in a convenient position to the user.

In an alternative embodiment, a single page, double sided menu can be accommodated by sandwiching the menu between two pieces of transparent material. The menu is illuminated manually by use of a switch or button located on the document holder.

### BRIEF DESCRIPTION OF THE DRAWINGS

In the drawings,

FIG. 1 is a perspective view of the illuminated portfolio folder;

FIG. 2 is a cutaway view of the internal circuitry of the illuminated portfolio folder;

FIG. 3 is an alternate placard style embodiment of FIG. 1; and

FIG. 4 is a double sided slip frame alternate embodiment of an illuminated document holder.

### DESCRIPTION OF THE PREFERRED EMBODIMENTS OF THE INVENTION

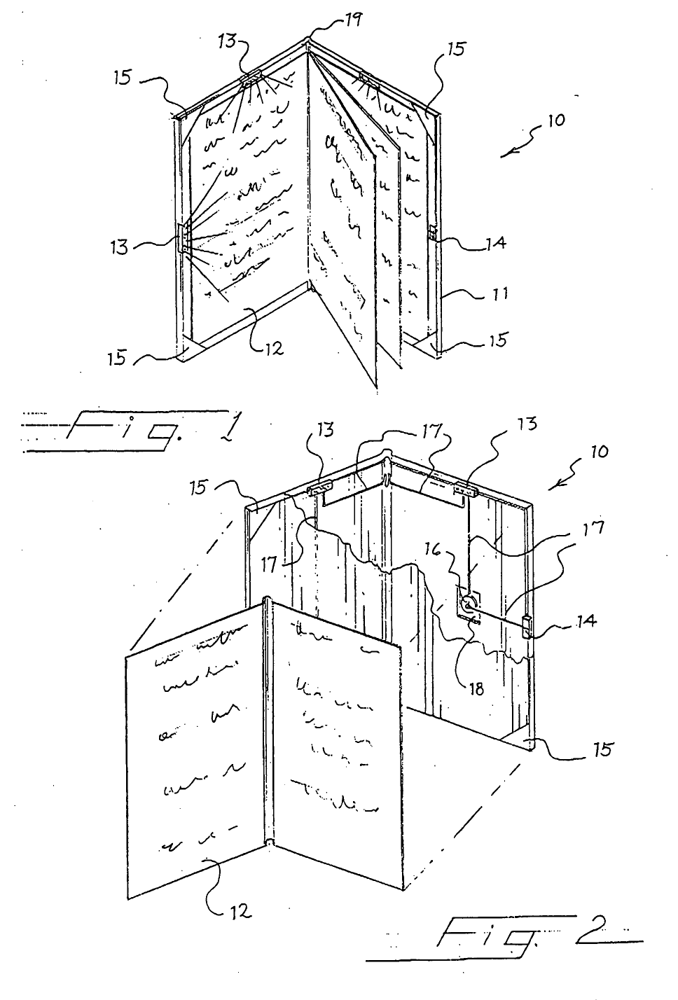

Referring now to the drawings, FIG. 1 shows an illuminated document holder 10 according to the preferred embodiment of the present invention. A document 12, in this case a multiple page menu, is supported by the surface of a substrate 11, shown here as a portfolio folder. The menu 12 is held by the portfolio folder 11 through the use of retaining means, such as corner pockets 15. Menu 12 can also be attached to folder 11 by the use of adhesives, although retaining means such as corner pockets, sleeves, or pockets permit the device 10 to be reused with new updated menus. The surface of portfolio folder 11 can be covered with leather, plastic, or any other aesthetically pleasing material.

Embedded within folder 11 is a power source 16. The power source 16 is preferably compact and long lasting, such as a lithium watch battery. The battery 16 can be accessible through a removable access panel 18 in folder 11. In use, the access panel 18 is obscured from view by the menu 12. Portfolio folder 11 is preferably of dimensions capable of concealing battery 16 without an unsightly bulge, although operation of the device would not be hampered in any way.

At least one light source 13 is secured to the surface of the substrate folder 11. While the light source can be any low powered, low heat, lightweight and reliable illumination source, the light source 13 is preferably at least one light emitting diode (“LED”). Light strips or other illumination mechanisms may also be used. In the preferred embodiment, the LED 13 directs light towards the center of the document page 12 held by the portfolio folder 11. The LED should be chosen to provide light of a quality such that the page is illuminated for comfortable reading while localizing the light beam to minimize excessive brightness and illumination outside the desired area. While the LED 13 can be placed in any position and orientation relative to the document 12 to be illuminated, the LED is optimally placed on the outside edge of the portfolio folder 13 and oriented so the light is directed towards the centerline 19 of the folder to minimize errant light pollution.

FIG. 2 shows the internal circuitry of the illuminated document holder 10. The embedded power source 16 is accessible by a removable access panel 18. The light source 13 and the power source 16 are electrically connected by wiring 17 to a switch 14. Switch 14 may be of a pull tab type switch so that the switch 14 is automatically open or closed depending on whether the folder 11 is closed or open respectively. For example, the switch can be a slidable contact switch where one end of the tab is in contact with the switch and the other end of the tab is secured to the folder across the centerline of the folder from the switch. When the folder is opened, the sliding of the tab in the switch automatically activates the switch. In this manner, opening the folder 11 will close switch 14, supplying power to illuminate LED 13. When the patron is finished with the menu, closing the folder 11 will open the electrical circuit governed by switch 14, shutting off the LED 13 and conserving the battery 16.

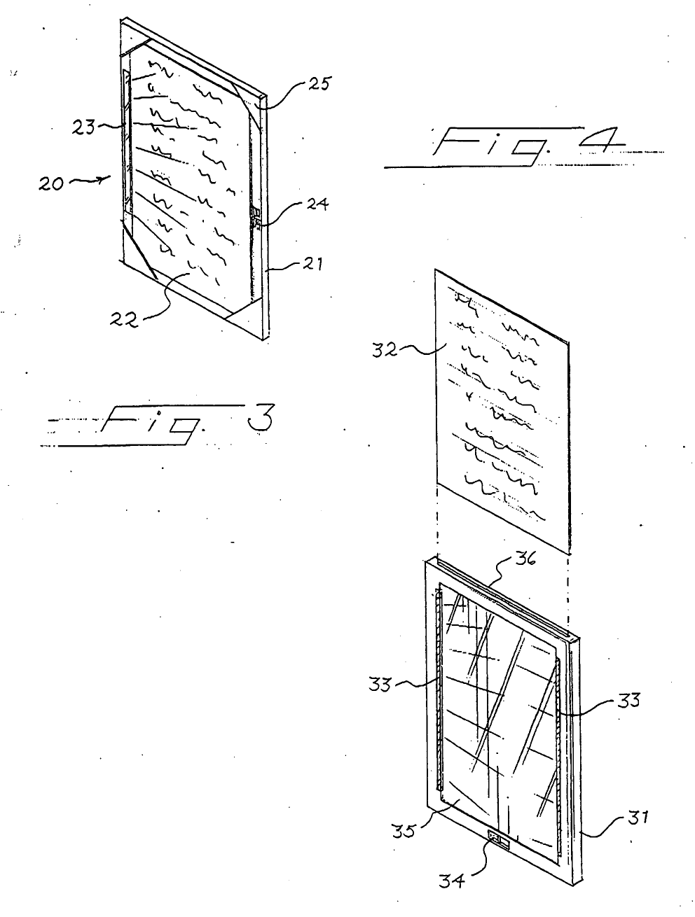

FIG. 3 shows an alternative embodiment of the invention for use with single page menus such as dessert or daily specials menus. Menu 22 is held in place to holder 21 at the corners by tabs 25. A light strip 23 controlled by a manually activated switch 24 provides illumination for reading the menu.

Still another embodiment, particularly suited for double sided menus or those that change often (such as the daily special in a seafood restaurant), is shown in FIG. 4. Holder 31 frames two panes of glass, plastic or other transparent material 35. A menu 32 can be inserted through a slot 36 in the holder. This embodiment permits the user to flip the holder 31 over to view the reverse side of menu 32.

In this embodiment shown in FIG. 4, a third lighting option is shown. Holder 31 houses a switch 34 electrically connected to LEDs and a power source (not shown). A fiberoptic cable 33 is secured to the inside perimeter of holder 31. The cladding on the fiberoptic cable 33 is periodically perforated so that when light from an LED (not shown) is directed into the fiberoptic cable, light leaks out of the cable at the perforated cladding sites to provide a diffuse lighting effect. Ideally, the fiberoptic cable runs around all four edges of the holder and an LED or other directed low power light source is directed into both ends of the fiberoptic cable 33 to account for attenuation and provide even lighting around the perimeter of the holder 31. A different lighting effect can be accomplished using a number of fiberoptic cables 33 with the proximal ends bundled and distal ends disposed around the edge of the holder 31. Illumination is achieved by the fiberoptic cables 33 serving as a conduit of light emitted by a hidden LED near the bundled end to the various distal end lighting points around the perimeter of holder 31.

While the illuminated document holders are described above in the context of restaurant menus, it is understood that the illuminated document holder is suitable for accomplishing similar functions in other low light situations to improve the readability of a document.

While the various descriptions of the present invention are described above, it should be understood that the various features can be used singly or in combination thereof. Therefore, this invention is not to be limited to the specific preferred embodiments depicted herein. Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

What is claimed is:

1. A hand-held device suitable for illumination of a document comprising:
a portfolio folder comprising a front cover and a rear cover in connection with said front cover;
said portfolio folder defining a surface comprising dimensions at least substantially the same size as one page of the document;
said portfolio folder further comprising a retaining mechanism for removably securing the document to the portfolio folder;
an illumination source electrically connected in series to a power source and a switch;
said illumination source being secured to the surface of said portfolio folder; and
whereby opening said portfolio folder activates the illumination source to provide light on the face of the document.

2. The device of claim 1, wherein said power source comprises a battery.

3. The device of claim 1, wherein said light source comprises a light emitting diode.

4. The device of claim 1, wherein the illumination source comprises a light strip.

5. The device of claim 1, wherein the illumination source further comprises a fiberoptic.

6. The device of claim 1, wherein said retaining mechanism comprise corner tabs.

7. The device of claim 1, wherein said retaining mechanism is a sleeve having at least one transparent face.

8. A hand-held device suitable for illumination of a document comprising:
a substrate capable of supporting at least one page of a document, whereby said substrate is at least substantially the same size as said document;
a power source;
a light source electrically connected to said power source;
a switch electrically connected to the light source and power source for controlling the light; and
wherein said light source is disposed on the surface of said substrate; and
whereby said light source illuminates a page of the document.

9. The device of claim 8, wherein said switch is activated manually.

10. The device of claim 8, wherein the illumination source comprises a light emitting diode.

11. The device of claim 8, wherein the illumination source comprises a light strip.

12. The device of claim 8, wherein the illumination source further comprises a fiberoptic.
